(19) United States
(12) Patent Application Publication
(10) Pub. No.: US 2006/0265282 A1
(43) Pub. Date: Nov. 23, 2006

(54) Swimwear vending method

(76) Inventors: Christophe Henley, Skandia, MI (US); Kimberly A. Bryan-Henley, Skandia, MI (US)

Correspondence Address: LITMAN LAW OFFICES, LTD, PO BOX 15035, CRYSTAL CITY STATION, ARLINGTON, VA, 22215, US

(21) Appl. No.: 11/433,468

(22) Filed: May 15, 2006

Related U.S. Application Data
(60) Provisional application No. 60/682,386, filed on May 19, 2005.

(51) Int. Cl. G07G 1/14; G06Q 20/00; G06Q 30/00

(52) U.S. Cl. 705/14; 705/16

(57) ABSTRACT

Swimsuit apparel is vended in machines at unattended sales locations proximate to swimming areas and in locations where potential swimsuit apparel customers travel to reach swimming areas. The swimsuit apparel is formed into a compact shape either by mechanical or vacuum compression. The swimsuit apparel in its compact shape is then vacuum packaged and inserted into a container suitably sized and labeled for vending the swimsuit apparel and container from standard vending machines.

### CROSS-REFERENCE TO RELATED APPLICATION

This application claims the benefit of U.S. Provisional Patent Application Serial No. 60/682,386, filed May 19, 2005.

### BACKGROUND OF THE INVENTION

The invention relates to packaged swimsuits, and methods and apparatus for forming, packaging, storing, displaying, and selling swimsuits in vending machines at swimming locations and locations where potential customers travel to swimming locations. Prior methods and apparatus for forming, packaging, storing, displaying, and selling swimsuit articles have various drawbacks.

### SUMMARY OF THE INVENTION

Accordingly, the present invention is directed to prepackaged swimsuit articles for sale in vending machines, and methods and apparatus for forming, packaging, storing, displaying, and selling swimsuit articles that overcome one or more of the problems due to the limitations and disadvantages of the related art.

Additional features and advantages of the invention will be set forth in the description which follows, and in part will be apparent from the description, or may be learned by practice of the invention. The objectives and other advantages of the invention will be realized and attained by the process, apparatus, and articles particularly in the written description, claims, and drawings that follow.

To achieve these and other advantages and in accordance with the purpose of the invention, as embodied and broadly described, one aspect of the invention provides a method and apparatus for vending swimsuit apparel in vending machines, forming the swimsuit apparel into a compact shape, shrink wrapping the swimsuit apparel in a shrink wrapping material, inserting the shrink wrapped swimsuit apparel into a container suitable for a vending machine configured to receive the container, and vending the swimsuit apparel and container from a vending machine.

In accordance with another aspect of the invention, a method is set forth for providing swimsuit apparel comprising, providing a container, highly compressing swimsuit apparel into a shape suitable for storage in the container, and inserting the highly compressed swimsuit apparel into the container.

It is to be understood that both the foregoing general description and the following detailed description are exemplary and explanatory and are intended to provide further explanation of the invention as claimed.

These and other features of the present invention will become readily apparent upon further review of the following specification and drawings.

### BRIEF DESCRIPTION OF THE DRAWINGS

Other objects of this invention will appear in the following description and appended claims, reference being made to the accompanying drawings forming a part of the specification where in like reference characters designate corresponding parts in the several views.

FIG. 1 is a perspective view of the swimsuit article.

FIG. 2 is a perspective view of a compressed swimsuit article.

FIG. 3 is a perspective view of a compressed swimsuit article contained in a shrink-wrapped package.

FIG. 4 is a perspective view of a compressed swimsuit article contained in a shrink-wrapped package inserted in a container suitably sized for a vending machine.

FIG. 5 is a perspective view of the compressed swimsuit article contained in a shrink-wrapped package inserted into a container suitably sized for a vending machine displaying a label describing gender, age, and size of the swimsuit article.

FIG. 6 is a front view of a typical vending machine for display and vending compacted, compressed swimsuit articles packaged in containers for girls, boys, lady's and men's swimsuits in small, medium and large sizes.

FIG. 7 is a perspective view of a vending machine control panel with a credit card processor for a credit card, smart card, debit card, and/or other purchase card.

Similar reference characters denote corresponding features consistently throughout the attached drawings.

### DETAILED DESCRIPTION OF THE PREFERRED EMBODIMENTS

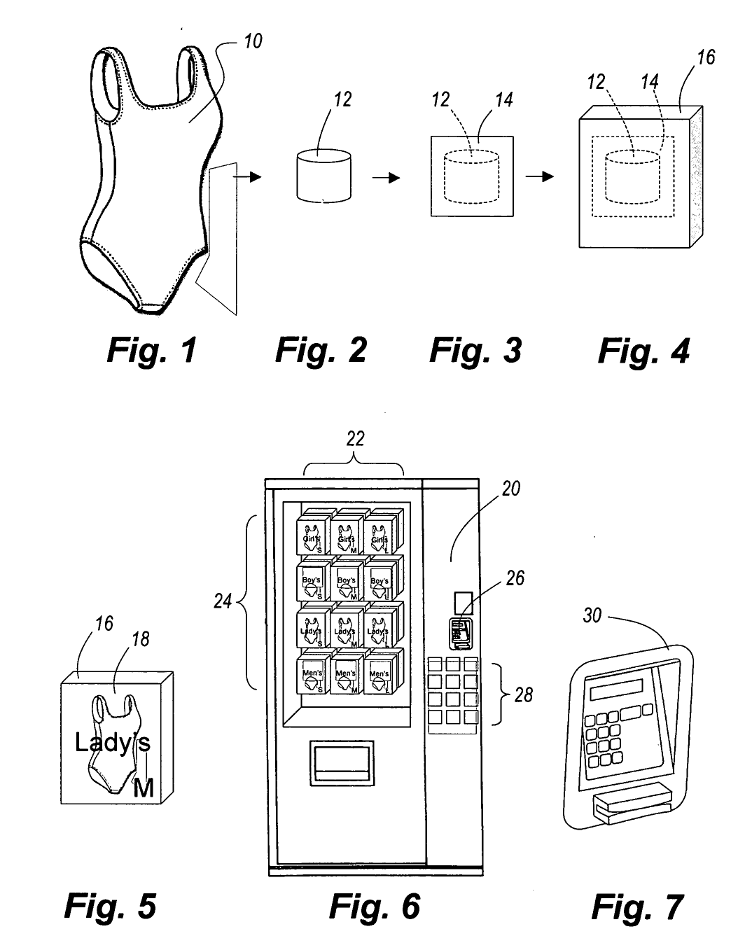

The drawings and description show and describe various methods and apparatus for forming, packaging, storing, displaying, and selling swimsuit articles, also known as swimsuit apparel. FIG. 1 shows a swimsuit article 10. Referring to FIG. 2, there is shown, rather schematically, a compressed swimsuit article 12. Compressed swimsuit article 12 may be a men's, woman's, boy's or girl's swimsuit item. Various methods of compressing fabric, and particularly swimsuit articles, to a substantially rigid article having a relatively small volume are known in the prior art. One such method is discussed in U.S. Pat. No. 5,172,629, issued Dec. 22, 1992, to Wayne M. Merry, and incorporated herein in its entirety by reference. For example, a conventional T-shirt, sized for an adult, may readily be compressed to a disk between about 1 inch and 4 inches in height and two inches and four inches in diameter. By use of known compression techniques, the swimsuit article is not damaged, and may be recovered from its compressed state by the purchaser.

One such method of mechanically compressing clothing articles to a substantially rigid article having a relatively small volume is to insert the clothing article into a mold or die having a cavity which is closed at one end. A plunger, dimensioned to form a close sliding fit in the cavity, is then inserted into the cavity, and a desired pressure applied to it for a certain period of time. By use of this method, the clothing article is compressed sufficiently to form a generally stable, solidified body, which may be returned to its original shape by an end user through manipulation or even by adding water to the article. Generally the shape of the cavity in the dye and the shape of the plunger, as well as the distance into the cavity the plunger must travel, are determined empirically based on the size and shape of the compressed clothing article.

In an additional method, in accordance with the present invention, a swimsuit article may be compressed by a vacuum compression method. One such method is discussed in U.S. Pat. No. 5,737,906, issued Apr. 14, 1998, to Hajime Ishimaru, and incorporated herein in its entirety by reference. For example, a pressure reducing apparatus is used in a vacuum packaging of clothing, food or the like in order to quickly shift in the interior of a preservation bake from the atmospheric state to a pressure reduced state; a reservoir take is provided which is connected to a rotary palm functioning as a vacuum pump.

Referring to FIG. 3, a vacuum compressed swimsuit article 12 is packaged into a vacuum packaging or shrink-wrapped material 14 to retain the compressed shape of the swimsuit article 12. The compressed to swimsuit article 12 is depicted in broken lines.

Referring to FIG. 4, there is shown a compressed swimsuit article 12 inserted into a container 16. Compressed swimsuit article 12 and a vacuum packaging or shrink-wrapped material 14 are depicted in broken lines. Container 16 may be made of metal, plastic, paperboard or any conventional container material employed for storage of items contained in vending machines. The swimsuit article may be first vacuum-shrunk and shrink-wrapped in clear plastic using conventional methods to allow for easy visual identification after shrink wrapping and before insertion into container 16, and to seal the compressed swimsuit article 12 from air and moisture during transportation, handling, and storage in any conventional vending machine. The swimsuit article may be then placed in the container, and closed in a conventional manner.

As shown in FIG. 5, text and graphical material 18 may be applied directly to any outer surface of container 16 by screen-printing or other conventional techniques. Alternatively, labels may be applied with glue or other adhesive to the exterior sidewall of container 16 or directly to the shrink-wrapped material 14. Labels may cover the entire surface of container 16 or any selected portion thereof. The text and graphical material 18, as represented in FIG. 5, may portray and describe the swimsuit article contained in the can, such as the gender and relative age the swimsuit is designed for, i.e., girl's, boy's, lady's, men's. Additionally, the text and graphical material may portray the size of the swimsuit, i.e., small, medium, large, extra-large, etc. Finally, the text and graphical material may actually portray the colors and/or designs of the swimsuits in the containers 16.

Referring now to FIG. 6, an additional advantage of providing text and graphical material 18 directly applied to either the surface of container 16 or to the surface of shrink wrapped material 14 is that it enables prospective customers to see the swimsuit articles 10 with the text and graphic labels on vending machines 20 that visually display goods offered for sale. In one example, where containers 16 have printed text or graphical material 18 on them, containers and 16 having swimsuit articles 10 may be sorted by size, as indicated by ref. no. 22, depicting containers 16 having small (S), medium (M), and large (L) sizes of swimwear apparel. Additionally, ref. no. 24 depicts swimwear apparel in containers 16 categorized by gender and age, i.e., girl's, boy's, lady's, and men's. Vending machines having no visual display of the products offered for sale therein, may have appropriate graphic and text representations of the products in the machines on product selection buttons 28 or other menu displays on vending machines.

Vending machine 20 may be, by way of example, a conventional vending machine used for the vending of canned beverages, prepackaged goods, and the like. Such machines are available, in a variety of capacities and configurations, from numerous vendors. In such a machine, containers are stored in numerous stacks or compartments. Such a machine is stocked by a human user, who unlocks a lock, to permit a door to be opened, to provide access to the interior of the vending machine. To obtain goods from the machine, a user operates a payment mechanism 26 that detects when sufficient funds have been deposited to make a purchase. The user then presses one of several product selection buttons 28 to select an item for purchase. The purchased item is permitted to fall to a delivery shelf by conventional techniques.

The vending machine 20 may accept cash at the payment mechanism 26 when swimsuit articles are priced sufficiently low enough to make coin and bill transactions feasible. However, when the prices of swimsuit articles are sufficiently high enough to render credit card purchases more feasible over cash purchases, vending machine 20 may be equipped with an automated credit card reader and verification device 30, of FIG. 7, to be used for the purchase of swimsuit articles 10 contained in containers 16.

The credit card reader 30 may read various credit cards, smart cards, debit cards, and/or other purchase cards. In accordance with conventional credit card reader and verification device technology, credit card reader and verification device 30 contains a card reader, a modem coupled to a telephone line, and suitable processors and memory to obtain card identification information magnetically encoded on a credit card, open a telephone connection to a credit card verification facility, transmit via such telephone connection information identifying the vending machine, the credit card, and the amount of the proposed purchase, to the credit card verification facility, receive an indication of purchase approval or disapproval, cause the vending machine to dispense the swimsuit apparel upon receipt of purchase approval, print a customer receipt, and transmit confirmation of the transaction to a processing facility. Device 30 may also be configured to transmit information, such as purchase information and inventory information, to a remote computer of the owner and/or operator of the vending machine. As shown, device 30 also is provided with a numeric keypad to permit entry of numeric information, such as personal identification numbers for use of debit cards. The credit card reader and verification device 30 also contains a display for providing use instructions, information regarding card approval or disapproval, and other information.

There are various advantages to the process of the invention over the prior art. In the prior art, clothing items, and particularly T-shirts, that have not been compressed, are displayed in the store on hangers or folded and placed on flat display surfaces. As consumers inspect the clothing items in the store, the clothing items are typically handled many times. As a result, the clothing items frequently become soiled or damaged and may no longer be sold.

When swimsuits are compressed before shipping, they may be conventionally shrink-wrapped in clear plastic. Swimsuit items that have been compressed and shrink wrapped occupy a smaller volume than swimsuit items that are being shipped conventionally, and are not subject to direct handling by consumers, and are therefore advantageous when compared with conventional shipping and display of swimsuit items. However, the appearance of a compressed swimsuit article that has been shrink-wrapped in clear plastic may not be particularly attractive to the consumer. Moreover, compressed swimsuit items that have been shrink wrapped in plastic tend to slide when stacked, and therefore fall readily when stacked on tables or shelves for in-store display.

The method of the present invention provides a superior method for displaying compressed swimsuit articles, by providing a surface for direct printing of information or for application of printed labels. Moreover, containers containing compressed swimsuit items may be rigid and uniform and therefore may be readily stacked for display. Shrink-wrapped swimsuit items cannot be readily stacked. A sealed container may also provide protection against sharp objects which would penetrate a plastic film.

Containers containing swimsuit articles may be readily adapted for sale in vending machines. Swimsuits that have been packaged in shrink wrap, clear plastic bags, or other conventional packaging, depending on the product dispensing configuration of a particular vending machine, may not be placed in or dispensed efficiently unless fit within special containers. As the containers are rigid and of a uniform size, they are well suited to mechanical handling. Swimsuit articles of different types or of different sizes, when packaged in shrink wrap or plastic bags, are not of uniform size and shape and, even when compressed, not as rigid as sealed containers.

The use of containers of conventional sizes permits the use of existing vending and dispensing machines. The use of vending machines also permits the sale of swimsuit at locations that have too low a volume, are too small, or otherwise are unsuitable for the use of clerks to accomplish sales. The vending machine may be located at hotels, resorts, airports, train stations, sporting facilities, cruise ships, water theme parks, and other locations where swimming areas or patrons traveling to swimming areas may pass through. As there is no handling of the containers after the vending machines are loaded, there is less opportunity for shrinkage than there is when clerks and consumers handle the retail merchandise.

It is to be understood that the present invention is not limited to the embodiments described above, but encompasses any and all embodiments within the scope of the following claims.

We claim:

1. A method for packaging and vending swimsuit apparel, comprising:
forming said swimsuit apparel into a compact shape;
vacuum packaging said swimsuit apparel in said compact shape;
inserting said vacuum packaged swimsuit apparel into a container;
labeling said container containing said vacuum packaged swimsuit apparel based on gender, age and size designations; and
offering said labeled container containing said vacuum packaged swimsuit apparel for sale in a vending machine, said vending machine located proximate to a swimming area or in an area where potential customers travel through to reach a swimming area.

2. The method for packaging and vending swimsuit apparel as recited in claim 1, further comprising the step of shrink-wrapping said swimsuit apparel in a shrink-wrap material.

3. The method for packaging and vending swimsuit apparel as recited in claim 2, further comprising the step of applying labeling directly to the shrink-wrap material encasing the swimsuit apparel.

4. The method for packaging and vending swimsuit apparel as recited in claim 3, wherein the labeling applied to the shrink-wrap material includes a graphic representation of the swimsuit apparel within the shrink-wrap material.

5. The method for packaging and vending swimsuit apparel as recited in claim 1, wherein the labeling applied to the container includes a graphic representation of the swimsuit apparel within the container.

6. The method for packaging and vending swimsuit apparel as recited in claim 1, wherein the vending machine is configured to display swimsuit apparel in at least four rows, including at least a first row of girl's swimsuits in small, medium and large sizes, at least a second row of boy's swimsuits in small, medium and large sizes, at least a third row of lady's swimsuits in small, medium and large sizes, and at least a fourth row of men's swimsuits in small, medium and large sizes.

7. A method for packaging and vending swimsuit apparel, comprising:
forming said swimsuit apparel into a compact shape;
compressing said swimsuit apparel into said compact shape;
inserting said compressed packaged swimsuit apparel into a container;
labeling said container containing said packaged swimsuit apparel based on gender, age and size designations; and
offering said labeled container containing said compact packaged swimsuit apparel for sale in a vending machine, said vending machine located proximate to a swimming area or in an area where potential customers travel through to reach a swimming area.

8. The method for packaging and vending swimsuit apparel as recited in claim 7, wherein the swimsuit is compressed into a disk-shaped configuration.

9. The method for packaging and vending swimsuit material as recited in claim 7, wherein the swimsuit is compressed by a plunger fitted into a die.

10. The method for packaging and vending swimsuit apparel as recited in claim 7, further comprising the step of shrink-wrapping said swimsuit apparel in a shrink-wrap material.

11. The method for packaging and vending swimsuit apparel as recited in claim 10, further comprising the step of applying labeling directly to the shrink-wrap material encasing the swimsuit apparel.

12. The method for packaging and vending swimsuit apparel as recited in claim 11, wherein the labeling applied to the shrink-wrap material includes a graphic representation of the swimsuit apparel within the shrink-wrap material.

13. The method for packaging and vending swimsuit apparel as recited in claim 7, wherein the labeling applied to the container includes a graphic representation of the swimsuit apparel within the container.

14. The method for packaging and vending swimsuit apparel as recited in claim 7, wherein the vending machine is configured to display swimsuit apparel in at least four rows, including at least a first row of girl's swimsuits in small, medium and large sizes, at least a second row of boy's swimsuits in small, medium and large sizes, at least a third row of lady's swimsuits in small, medium and large sizes, and at least a fourth row of men's swimsuits in small, medium and large sizes.
